(19) United States
(12) Patent Application Publication
(10) Pub. No.: US 2023/0246237 A1
(43) Pub. Date: Aug. 3, 2023

(54) NOVEL FLUORINATED ETHERS AS ELECTROLYTE SOLVENTS FOR LITHIUM METAL, SODIUM METAL, MAGNESIUM METAL OR SULFUR BATTERIES

(71) Applicant: UCHICAGO ARGONNE, LLC, Chicago, IL (US)

(72) Inventors: Lu Zhang, Naperville, IL (US); Zhangxing Shi, Chicago, IL (US); Sambasiva R. Bheemireddy, Woodridge, IL (US); Zhou Yu, Bridgeview, IL (US); Lei Cheng, Naperville, IL (US)

(73) Assignee: UCHICAGO ARGONNE, LLC, Chicago, IL (US)

(21) Appl. No.: 17/588,769

(22) Filed: Jan. 31, 2022

(51) Int. Cl. H01M 10/0569; H01M 10/0567

(52) U.S. Cl. CPC H01M 10/0569; H01M 10/0567; H01M 2300/0034

(57) ABSTRACT

An electrochemical cell includes a cathode including a cathode active material; an anode including silicon, conductive carbon, lithium metal, sodium metal, magnesium metal, sulfur, or a combination of any two or more thereof; a separator; and an electrolyte including a lithium sulfonylimide salt, an asymmetric fluorinated glycol ether, and optionally an electrolyte additive, an aprotic gel polymer, or a mixture thereof.

### GOVERNMENT RIGHTS

This invention was made with government support under Contract No. DE-AC02-06CH11357 awarded by the United States Department of Energy to UChicago Argonne, LLC, operator of Argonne National Laboratory. The government has certain rights in the invention.

### FIELD

The present technology is generally related to lithium rechargeable batteries. More particularly the technology relates to the use of asymmetric fluorinated glycol ethers and lithium salt in an electrochemical cell having an anode containing lithium metal, sodium metal, or magnesium metal.

### SUMMARY

In one aspect, an electrochemical cell is provided having a cathode comprising a cathode active material; an anode comprising silicon, conductive carbon, lithium metal, sodium metal, magnesium metal, or a combination of any two or more thereof; a separator; and an electrolyte comprising a lithium salt, an asymmetric fluorinated glycol ether, and optionally an electrolyte additive, an aprotic gel polymer, or a mixture thereof. In some embodiments, the electrochemical cell is a lithium battery such as a lithium secondary battery, a lithium sulfur battery, or a lithium air battery.

### BRIEF DESCRIPTION OF THE DRAWINGS

FIGS. 1A-1B illustrate the discharge capacity (FIG. 1A) and Coulombic efficiency (FIG. 1B) as a function of cycle number for 1 M TFSI in F2O3 or DME electrolytes and 1 M LiPF₆ in EC/EMC (3/7) and 2% vinylene carbonate, according to the examples.

FIG. 2 is a linear sweep voltammogram for 1 M LiTFSI in F2O3 or F3O3, with both asymmetric fluorinated ethers showing excellent stability at high potential, according to the examples.

FIG. 3 is a graph of conductivity measurements for 1 M LiTFSI in F2O3 or F3O3 using electrochemical impedance spectroscopy, showing a measured conductivity for F2O3 electrolyte of 1.81 mS/cm, and a measured conductivity for F3O3 electrolyte of 0.76 mS/cm, according to the examples.

### DETAILED DESCRIPTION

Various embodiments are described hereinafter. It should be noted that the specific embodiments are not intended as an exhaustive description or as a limitation to the broader aspects discussed herein. One aspect described in conjunction with a particular embodiment is not necessarily limited to that embodiment and can be practiced with any other embodiment(s).

As used herein, “about” will be understood by persons of ordinary skill in the art and will vary to some extent depending upon the context in which it is used. If there are uses of the term which are not clear to persons of ordinary skill in the art, given the context in which it is used, “about” will mean up to plus or minus 10% of the particular term.

The use of the terms “a” and “an” and “the” and similar referents in the context of describing the elements (especially in the context of the following claims) are to be construed to cover both the singular and the plural, unless otherwise indicated herein or clearly contradicted by context. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the embodiments and does not pose a limitation on the scope of the claims unless otherwise stated. No language in the specification should be construed as indicating any non-claimed element as essential.

In general, “substituted” refers to an alkyl, alkenyl, alkynyl, aryl, or ether group, as defined below (e.g., an alkyl group) in which one or more bonds to a hydrogen atom contained therein are replaced by a bond to non-hydrogen or non-carbon atoms. It should be noted that unless otherwise indicated any alkyl, alkenyl, alkynyl, aryl, ether, ester, or the like may be substituted, whether indicated as substituted or not. Substituted groups also include groups in which one or more bonds to a carbon(s) or hydrogen(s) atom are replaced by one or more bonds, including double or triple bonds, to a heteroatom. Thus, a substituted group will be substituted with one or more substituents, unless otherwise specified. In some embodiments, a substituted group is substituted with 1, 2, 3, 4, 5, or 6 substituents. Examples of substituent groups include: halogens (i.e., F, Cl, Br, and I); hydroxyls; alkoxy, alkenoxy, alkynoxy, aryloxy, aralkyloxy, heterocyclyloxy, and heterocyclylalkoxy groups; carbonyls (oxo); carboxyls; esters; urethanes; oximes; hydroxylamines; alkoxyamines; aralkoxyamines; thiols; sulfides; sulfoxides; sulfones; sulfonyls; sulfonamides; amines; N-oxides; hydrazines; hydrazides; hydrazones; azides; amides; ureas; amidines; guanidines; enamines; imides; isocyanates; isothiocyanates; cyanates; thiocyanates; imines; nitro groups; nitriles (i.e., CN); and the like.

As used herein, “alkyl” groups include straight chain and branched alkyl groups having from 1 to about 20 carbon atoms, and typically from 1 to 12 carbons or, in some embodiments, from 1 to 8 carbon atoms. As employed herein, “alkyl groups” include cycloalkyl groups as defined below. Alkyl groups may be substituted or unsubstituted. Examples of straight chain alkyl groups include methyl, ethyl, n-propyl, n-butyl, n-pentyl, n-hexyl, n-heptyl, and n-octyl groups. Examples of branched alkyl groups include, but are not limited to, isopropyl, sec-butyl, t-butyl, neopentyl, and isopentyl groups. Representative substituted alkyl groups may be substituted one or more times with, for example, amino, thio, hydroxy, cyano, alkoxy, and/or halo groups such as F, Cl, Br, and I groups. As used herein the term haloalkyl is an alkyl group having one or more halo groups. In some embodiments, haloalkyl refers to a per-haloalkyl group.

Cycloalkyl groups are cyclic alkyl groups such as, but not limited to, cyclopropyl, cyclobutyl, cyclopentyl, cyclohexyl, cycloheptyl, and cyclooctyl groups. In some embodiments, the cycloalkyl group has 3 to 8 ring members, whereas in other embodiments the number of ring carbon atoms range from 3 to 5, 6, or 7. Cycloalkyl groups may be substituted or unsubstituted. Cycloalkyl groups further include polycyclic cycloalkyl groups such as, but not limited to, norbornyl, adamantyl, bornyl, camphenyl, isocamphenyl, and carenyl groups, and fused rings such as, but not limited to, decalinyl, and the like. Cycloalkyl groups also include rings that are substituted with straight or branched chain alkyl groups as defined above. Representative substituted cycloalkyl groups may be mono-substituted or substituted more than once, such as, but not limited to: 2,2-; 2,3-; 2,4-; 2,5-; or 2,6-disubstituted cyclohexyl groups or mono-, di-, or tri-substituted norbornyl or cycloheptyl groups, which may be substituted with, for example, alkyl, alkoxy, amino, thio, hydroxy, cyano, and/or halo groups.

Fluorination is a widely used strategy to increase the oxidation potential of organic compounds. However, it has been found that highly fluorinated organic solvents (e.g. hydrofluoroether) do not dissolve Li salts to any significant degree. Such highly fluorinated organic solvents also have low ionic conductivity. Both of these effects have limited the application of fluorinated organic solvents as suitable electrolyte solvents for Li metal batteries. However, it has now been found that by incorporation of a perfluorinated alkyl segment and an ether segment into highly fluorinated materials, the resulting compounds exhibit high oxidation potential and good solubility of lithium salts. By making such compounds, it has been found that they are promising electrolyte solvents for Li metal batteries paired with high-voltage cathodes such as lithium metal oxide cathodes, oxygen cathodes, and sulfur cathode. As a result, cells such cathodes paired with lithium metal anodes (i.e. lithium metal as sheets, foil, or sand), and a suitable electrolyte system exhibit significantly improved capacity retention and Coulombic efficiency compared to conventional carbonate-based electrolytes, or ether electrolytes. The batteries may have a voltage range of about 2 V to about 5 V, or from about 2 V to about 4.7 V.

In one aspect, an electrochemical cell includes a cathode comprising a cathode active material; an anode comprising silicon, conductive carbon, lithium metal, sodium metal, magnesium metal, or a combination of any two or more thereof; a separator; and an electrolyte comprising a lithium salt, an asymmetric fluorinated glycol ether, and optionally an electrolyte additive, an aprotic gel polymer, or a mixture thereof.

As noted above, the electrolyte is based upon an assymetric fluorinated glycol ether. The asymmetric fluorinated glycol ether may be a compound represented by Formula I:

R¹(O(CH₂)ₘ)ₓOR² (I).

In Formula (I) R¹ may be a C₁-C₈ alkyl substituted with 2 to 17 fluorine atoms; R² may be a C₁-C₆ alkyl; m may be 1, 2, or 3; and x may be 1, 2, 3, 4, 5, 6, 7, 8, 9 or 10. In any such embodiments, R¹ may be —(CH₂)_{q}(CR³R⁴)ₚR⁵; R³ and R⁴ may each be independently H or F; R⁵ may be —CHF₂ or —CF₃; and q and p may each independently be 1, 2, 3, or 4, with the proviso that q+p≤7. In other embodiments, le may be —CH₂CF₂CF₃ or —CH₂CF₂CF₂CF₃. In any of the above embodiments, R³ and R⁴ may be F; q may be 1 or 2; and p may be 1, 2, or 3. In some embodiments, R³ is H or F, and R⁴ is H or F. In any of the above embodiments, R⁵ may be —CF₃ or —CHF₂. In any of the above embodiments, R² may be CH₃, CH₂CH₃, or CH₂CH₂CH₃. In some embodiments, R² is CH₃.

The asymmetric fluorinated glycol ether generally described above includes a illustrative compounds, but not limited to:

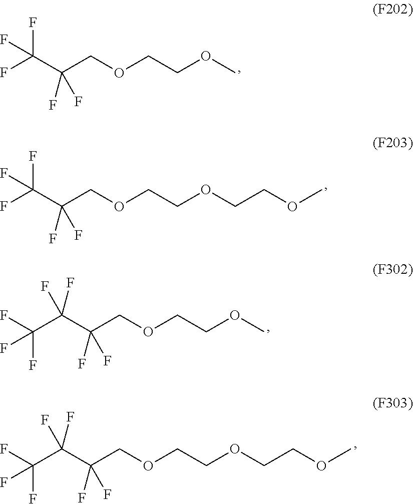 [SMILES: COCCOCC(F)(F)C(F)(F)F ; COCCOCCOCC(F)(F)C(F)(F)F ; COCCOCC(F)(F)C(F)(F)C(F)(F)F ; COCCOCCOCC(F)(F)C(F)(F)C(F)(F)F]

or a mixture of any two or more thereof.

To form highly stable solid-electrolyte interphase (SEI) on the lithium anode, lithium sulfonylimide salts may be used in the electrolyte. The lithium fluorosulfonylimide salt may include, but are not limited to, LiN(SO₂F)₂ (“LiFSI”); LiN(SO₂CF₃)₂ (“LiTFSI”); LiN(SO₂C₂F₅)₂; Li(SO₂F)N(SO₂CF₃); Li(SO₂F)N(SO₂CH₃); Li(SO₂F)N(SO₂C₂H₅); Li(SO₂F)N(SO₂C₂F₅); Li(SO₂F)N(SO₂CHF₂); Li(SO₂F)N(SO₂CH₂F); Li(SO₂F)N(SO₂CH₂CF₃); Li(SO₂F)N(SO₂CH₂CHF₂); Li(SO₂F)N(SO₂CHFCH₃); Li(SO₂F)N(SO₂CHFCF₃); Li(SO₂F)N(SO₂CHFCHF₂); Li(SO₂F)N(SO₂CHFCH₂F); Li(SO₂F)N(SO₂CF₂CH₃); Li(SO₂F)N(SO₂CF₂CF₃); Li(SO₂F)N(SO₂CF₂CHF₂); Li(SO₂F)N(SO₂CF₂CH₂F); Li(SO₂CF₃)N(SO₂CH₃); Li(SO₂CF₃)N(SO₂CHF₂); Li(SO₂CF₃)N(SO₂CH₂F); Li(SO₂CF₃)N(SO₂CH₂CF₃); and a mixture of any two or more thereof. In some embodiments, the lithium fluorinated sulfonylimide salt includes LiFSI or LiTFSI. The salt may be present in the electrolyte at a concentration from about 0.5M to 5M. The use of lithium fluorosulfonylimide salt with asymmetric fluorinated glycol ether offers profound synergistic effect in enabling the highly stable cycling of lithium metal batteries.

The electrochemical cells described herein may also include in the electrolytes, an electrolyte stabilizing additive that may be LiBF₂(C₂O₄), LiB(C₂O₄)₂, LiPF₂(C₂O₄)₂, LiPF₄(C₂O₄), LiPF₆, LiAsF₆, CsF, CsPF₆, Li₂(B₁₂X₁₂₋ᵢHᵢ), Li₂(B₁₀X_{10-i′}H_{i′}), or a mixture of any two or more thereof. In such additives, each X is independently at each occurrence a halogen, i is an integer from 0 to 12 and i′ is an integer from 0 to 10. In some embodiments, the electrolyte may also contain an electrode stabilizing additive such as but not limited to LiB(C₂O₄)₂, LiBF₂(C₂O₄)₂, 1,3,2-dioxathiolane-2,2-dioxide, ethylene sulfite, a spirocyclic hydrocarbon containing at least one oxygen atom and at least on alkenyl or alkynyl group, pyridazine, vinyl pyridazine, quinolone, pyridine, vinyl pyridine, 2,4-divinyl-tetrahydropyran, 3,9-diethylidene-2,4,8-trioxaspiro[5,5]undecane, 2-ethylidene-5-vinyl-[1,3]dioxane, anisoles, 2,5-dimethyl-1,4-dimethoxybenzene, 2,3,5,6-tetramethyl-1,4-dimethoxybenzene, 2,5-di-tert-butyl-1,4-dimethoxybenzene, or a mixture of two or more thereof. The electrolyte additive may be present at a concentration of less than about 5 wt %. The electrolyte additive may be present at a concentration of from about 0.01 wt % to about 5 wt %.

In further embodiments, the electrolyte may further include an aprotic gel polymer. For example, mixtures of poly(ethylene oxide) (PEO) with lithium salts and an organic aprotic solvent may be used.

In some embodiments, the electrolyte may also include a redox shuttle material. The shuttle, if present, will have an electrochemical potential above the positive electrode's maximum normal operating potential. Illustrative stabilizing agents include, but are not limited to, a spirocyclic hydrocarbon containing at least one oxygen atom and at least on alkenyl or alkynyl group, pyridazine, vinyl pyridazine, quinolone, pyridine, vinyl pyridine, 2,4-divinyl-tetrahydrooyran, 3,9-diethylidene-2,4,8-trioxaspiro[5,5]undecane, 2-ethylidene-5-vinyl-[1,3]dioxane, lithium alkyl fluorophosphates, lithium alkyl fluoroborates, lithium 4,5-dicyano (trifluoromethyl)imidazole, lithium 4,5-dicyano-2-methylimidazole, trilithium 2,2′,2″-tris(trifluoromethyl)benzotris(imidazolate), Li(CF₃CO₂), Li(C₂F₅CO₂), LiCF₃SO₃, LiCH₃SO₃, LiN(SO₂CF₃)₂, LiC(CF₃SO₂)₃, LiN(SO₂C₂F₅)₂, LiClO₄, LiAsF₆, Li₂(B₁₂X₁₂₋ᵢHᵢ), Li₂(B₁₀X_{10-I′}H_{i′}), wherein X is independently at each occurrence a halogen, I is an integer from 0 to 12 and I′ is an integer from 0 to 10, 1,3,2-dioxathiolane 2,2-dioxide, 4-methyl-1,3,2-dioxathiolane 2,2-dioxide, 4-(trifluoromethyl)-1,3,2-dioxathiolane 2,2-dioxide, 4-fluoro-1,3,2-dioxathiolane 2,2-dioxide, 4,5-difluoro-1,3,2-dioxathiolane 2,2-dioxide, dimethyl sulfate, methyl (2,2,2-trifluoroethyl) sulfate, methyl (trifluoromethyl) sulfate, bis(trifluoromethyl) sulfate, 1,2-oxathiolane 2,2-dioxide, methyl ethanesulfonate, 5-fluoro-1,2-oxathiolane 2,2-dioxide, 5-(trifluoromethyl)-1,2-oxathiolane 2,2-dioxide, 4-fluoro-1,2-oxathiolane 2,2-dioxide, 4-(trifluoromethyl)-1,2-oxathiolane 2,2-dioxide, 3-fluoro-1,2-oxathiolane 2,2-dioxide, 3-(trifluoromethyl)-1,2-oxathiolane 2,2-dioxide, difluoro-1,2-oxathiolane 2,2-dioxide, 5H-1,2-oxathiole 2,2-dioxide, 2,5-dimethyl-1,4-dimethoxybenzene, 2,3,5,6-tetramethyl-1,4-dimethoxybenzene, 2,5-di-tert-butyl-1,4-dimethoxybenzene or a mixture of any two or more thereof, with the proviso that when used, the redox shuttle is not the same as the lithium salt, even though they perform the same function in the cell. That is, for example, if the lithium salt is LiClO₄, it may also perform the dual function of being a redox shuttle, however if a redox shuttle is included in that same cell, it will be a different material than LiClO₄. The electrolyte additive may be present in the electrolyte in an amount of about 1% to about 10% by weight or by volume. This includes an amount of about 1% to about 8% by weight or by volume, about 1% to about 6% by weight or by volume, about 1% to about 4% by weight or by volume, or about 1% to about 3% by weight or by volume. In some embodiments, the electrolyte additive is present in the electrolyte in an amount of about 1, 2, 3, 4, 5, 6, 7, 8, 0.9, or 10% by weight or by volume.

Also as noted herein, the electrolyte may further include electrolyte additives to help stabilize the electrode, assist in include, but are not limited to LiBF₂(C₂O₄), LiB(C₂O₄)₂, LiPF₂(C₂O₄)₂, LiPF₄(C₂O₄), LiPF₆, LiAsF₆, CsF, CsPF₆, LiN(SO₂CF₃)₂, LiN(SO₂F)₂, Li₂(B₁₂X₁₂₋ᵢHᵢ); Li₂(B₁₀X_{10-i′}H_{i′}), or a mixture of any two or more thereof. As set forth, each X is independently a halogen, each i is an integer from 0 to 12 and each i′ is an integer from 0 to 10. The electrolyte additive may be present at a concentration of about 5 wt % or less. For example, the electrolyte additive when present, may be present at a concentration of about 0.1 wt % to about 5 wt %, about 1 wt % to about 5 wt %, or about 0.5 wt % to about 3 wt %.

In some embodiments, the electrolyte comprises greater than 20 wt % of the terminally fluorinated glycol ether. In some embodiments, the electrolyte comprises greater than 50 wt % of the terminally fluorinated glycol ether. In some embodiments, the electrolyte comprises greater than 75 wt % of the terminally fluorinated glycol ether. In some embodiments, the electrolyte comprises greater than 90 wt % of the terminally fluorinated glycol ether.

In some embodiments, the electrolyte consists essentially of the lithium salt, the terminally fluorinated glycol ether, and optionally the electrolyte additive.

As noted above, the electrochemical devices may include a cathode. The cathode may include oxygen (02), or sulfur (S), in some embodiments. In other embodiments, the cathode may include a metal oxide which may be, but is not limited to, a spinel, an olivine, a carbon-coated olivine LiFePO₄, LiMn_{0.5}Ni_{0.5}O₂, LiCoO₂, LiNiO₂, LiNi₁₋ₓCo_{y}Me_{z}O₂, LiNi_{α}Mn_{β}Co_{γ}O₂, LiMn₂O₄, LiFeO₂, LiNi_{0.5}Me_{1.5}O₄, Li_{1+x′}NiₕMnₖCoₗMe²_{y′}O_{2-z′}F_{z′}, VO₂ or E_{x″}E′₂(Me₃O₄)₃, LiNiₘMnₙO₄, wherein Me is Al, Mg, Ti, B, Ga, Si, Mn, or Co; Me² is Mg, Zn, Al, Ga, B, Zr, or Ti; E is Li, Ag, Cu, Na, Mn, Fe, Co, Ni, or Zn; E′ is Ti, V, Cr, Fe, or Zr; wherein 0≤x≤0.3; 0≤y≤0.5; 0≤z≤0.5; 0≤m≤2; 0≤n≤2; 0≤x′≤0.4; 0≤α≤1; 0≤β≤1; 0≤γ≤1; 0≤h≤1; 0≤k≤1; 0≤l≤1; 0≤y′≤0.4; 0≤z′≤0.4; and 0≤x″≤3; with the proviso that at least one of h, k and 1 is greater than 0. In some embodiments, the metal oxide includes Li_{1+W}MnₓNi_{y}Co_{z}O₂ wherein w, x, y, and z satisfy the relations 0<w<1, 0≤x<1, 0≤y<1, 0≤z<1, and x+y+z=1. In some embodiments, the metal oxide includes LiMnₓNi_{y}O₄ wherein x and y satisfy the 0≤x<2, 0≤y<2, and x+y=2. In some embodiments, the positive electrode includes LiMnₓNi_{y}O₄ wherein x and y satisfy the 0≤x<2, 0≤y<2, and x+y=2. In some embodiments, the positive electrode includes xLi₂MnO₃·(1−x)LiMO₂ is wherein 0≤x<2. In some embodiments, the cathode includes a metal oxide that is LiMn_{0.5}Ni_{0.5}O₂, LiCoO₂, LiNiO₂, LiNi₁₋ₓCo_{y}Mn_{z}O₂, or a combination of any two or more thereof. In one embodiment, the cathode includes a metal oxide that is LiCoO₂ (lithium cobalt oxide). In one embodiment, the cathode includes a metal oxide that is LiFePO₄ (lithium iron phosphate oxide (LFP)). In some embodiments, the metal oxide is a lithium nickel manganese cobalt oxide (NMC). For example, the cathode may include a metal oxide that is LiNi_{α}Mn_{β}Co_{γ}O₂, NMC111 (LiNi_{0.33}Co_{0.33}Mn_{0.3302}), NMC532 (LiNi_{0.5}Co_{0.2}Mn_{0.3}O₂), NMC622 (LiNi_{0.6}Co_{0.2}Mn_{0.2}O₂), NMC811 (LiNi_{0.8}Co_{0.1}Mn_{0.1}O₂) or a Ni-rich layer material such as Li_{1+x′}NiₕMnₖCoₗMe²_{y′}O_{2-z′}F_{z′} where 0≤h≤1. In some embodiments, the cathode comprises LiMn_{0.5}Ni_{0.5}O₂, LiCoO₂, LiNiO₂, LiNi₁₋ₓCo_{y}Mn_{z}O₂, or a combination of any two or more thereof, wherein 0≤x≤0.3; 0≤y≤0.5; 0≤z≤0.5. In some embodiments, the cathode active material comprises a spinel, an olivine, a carbon-coated olivine LiFePO₄, LiMn_{0.5}Ni_{0.5}O₂, LiCoO₂, LiNiO₂, LiNi₁₋ₓCo_{y}Me_{z}O₂, LiNi_{α}Mn_{β}Co_{γ}O₂, LiMn₂O₄, LiFeO₂, LiNi_{0.5}Me_{1.5}O₄, Li_{1+x′}NiₕMnₖCoₗMe²_{y′}F_{z′}, VO₂ or E_{x″}E′₂(Me₃O₄)₃, LiNiₘMnₙO₄, or a mixture of any two or ore thereof, wherein Me is Al, Mg, Ti, B, Ga, Si, Mn, or Co; Me² is Mg, Zn, Al, Ga, B, Zr, or Ti; E is Li, Ag, Cu, Na, Mn, Fe, Co, Ni, or Zn; E′ is Ti, V, Cr, Fe, or Zr; wherein 0≤x≤0.3; 0≤y≤0.5; 0≤z≤0.5; 0≤m≤2; 0≤n≤2; 0≤x′≤0.4; 0≤α≤1; 0≤β≤1; 0≤γ≤1; 0≤h≤1; 0≤k≤1; 0≤l≤1; 0≤y′≤0.4; 0≤z′≤0.4; and 0≤x″≤3; with the proviso that at least one of h, k and l is greater than 0. In some embodiments, the cathode active material comprises sulfur.

The term “spinel” refers to a manganese-based spinel such as, Li₁₊ₓMn_{2-y}Me_{z}O₄₋ₕAₖ, wherein Me is Al, Mg, Ti, B, Ga, Si, Ni, or Co; A is S or F; and wherein 0≤x≤0.5, 0≤y≤0.5, 0≤z≤0.5, 0≤h≤0.5, and 0≤k≤0.5.

The term “olivine” refers to an iron-based olivine such as, LiFe₁₋ₓMe_{y}PO₄₋ₕAₖ, wherein Me is Al, Mg, Ti, B, Ga, Si, Ni, or Co; A is S or F; and wherein 0≤x≤0.5, 0≤y≤0.5, 0≤h≤0.5, and 0≤k≤0.5.

The cathode may be further stabilized by surface coating the active particles with a material that can neutralize acid or otherwise lessen or prevent leaching of the transition metal ions. Hence, the cathodes may also include a surface coating of a metal oxide or fluoride such as ZrO₂, TiO₂, ZnO₂, WO₃, Al₂O₃, MgO, SiO₂, SnO₂, AlPO₄, Al(OH)₃, AlF₃, ZnF₂, MgF₂, TiF₄, ZrF₄, a mixture of any two or more thereof, of any other suitable metal oxide or fluoride. The coating can be applied to a carbon-coated cathode.

The cathode may be further stabilized by surface coating the active particles with polymer materials. Examples of polymer coating materials include, but not limited to, polysiloxanes, polyethylene glycol, or poly(3,4-ethylenedioxythiophene) polystyrene sulfonate, a mixture of any two or more polymers.

The anode may include silicon, conductive carbon, lithium metal, sodium metal, magnesium metal, or a combination of any two or more thereof. However, in some embodiments, the anode comprises lithium metal. In some embodiments, the anode comprises sodium metal. In some embodiments, the anode comprises magnesium metal. Any of these anode metals may be present in the device as a sheet, foil, sand, or other morphology. In some embodiments, the anode is a lithum foil. As a metal, the metal may be the current collector, or the metal may be connected to a current collector. In some embodiments, the conductive carbon is carbon nanotubes, carbon fiber, microporous carbon, mesoporous carbon, macroporous carbon, mesoporous microbeads, graphite, expandable graphite, polymer yield carbon, or carbon black.

The electrochemical cells disclosed herein may also include a porous separator to separate the cathode from the anode and prevent, or at least minimize, short-circuiting in the device. The separator may be a polymer or ceramic or mixed separator. The separator may include, but is not limited to, polypropylene (PP), polyethylene (PE), trilayer (PP/PE/PP), polymer films that may optionally be coated with alumina-based ceramic particles, solid electrolyte separators such as lithicon-type compounds such as Li₁₄Zn(GeO₄)₄, or nasicon-type compounds such as Li_{1.3}Al_{0.3}Ti_{1.7}(PO₄)₃ and Li_{1.5}Al_{0.5}Ge_{1.5}(PO₄)₃.

The electrodes of the electrochemical cells (i.e. the lithium batteries) may also include a current collector. Current collectors for either the anode or the cathode may include those of copper, stainless steel, titanium, tantalum, platinum, gold, aluminum, nickel, cobalt, cobalt nickel alloy, highly alloyed ferritic stainless steel containing molybdenum and chromium; or nickel-, chromium-, or molybdenum containing alloys.

The electrodes (i.e., the cathode and/or the anode) may also include a conductive polymer as a binder. Illustrative conductive polymers include, but not limited to, polyaniline, polypyrrole, poly(pyrrole-co-aniline), polyphenylene, polythiophene, polyacetylene, polysiloxane, polyvinylidene difluoride, or polyfluorene.

As an example of the electrochemical cells described herein are lithium secondary batteries. The lithium secondary batteries described herein may find application as a lithium battery, a lithium-air battery, or a lithium-sulfur battery.

The present invention, thus generally described, will be understood more readily by reference to the following examples, which are provided by way of illustration and are not intended to be limiting of the present invention.

### EXAMPLES

Example 1. Materials and Syntheses. Fluorinated ethers were obtained by using the following the synthesis as outlined in Scheme 1.

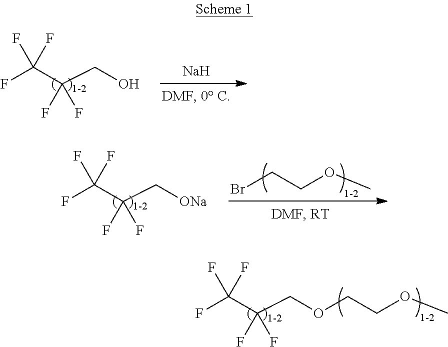

To a suspension of NaH (1 eq) in DMF was added a fluorinated alcohol (1 eq) dropwise under nitrogen atmosphere at 0° C. This mixture was stirred at 0° C. for 20 minutes, and then at room temperature for 10 minutes, followed by the addition of a bromo ether (0.5 eq) to the reaction mixture dropwise at room temperature. After stirring overnight, water was added to quench the reaction, and the final products were obtained by diethyl ether extraction and characterized by ¹H NMR.

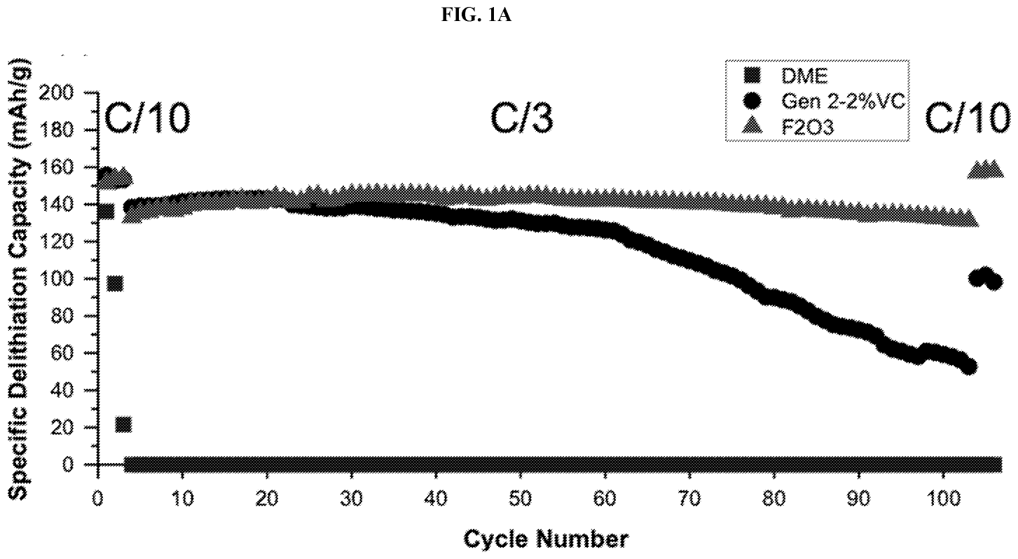

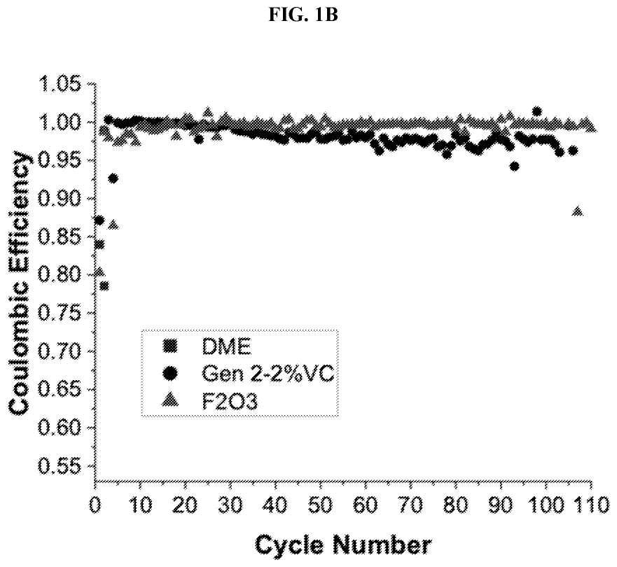

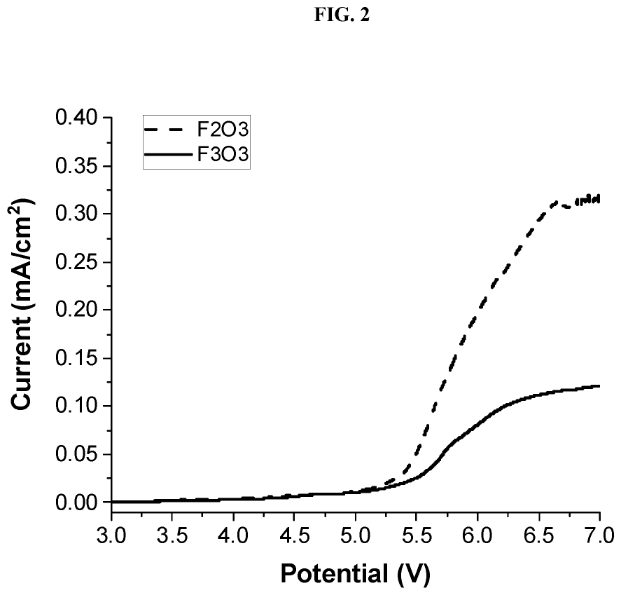

Example 2. Cells were prepared and the performance of the cells was tested. FIG. 1A shows the cell performance of FE-3 electrolyte (1 M LiTFSI in FE-3) in 2032 coin cells having a Li metal anode, a Celgard 2325 separator, and a NMC622 cathode. A comparative cells were also prepared using electrolytes of (A) 1 M LiTFSI in dimethoxyethane (DME), and (B) 1 M LiTFSI in 7:3 on vol basis ethylene carbonate (EC):ethylmethyl carbonate (EMC) with 2 wt % vinylene carbonate (VC). Comparative B is also referred to as “Gen 2-2% VC” (the 3:7 EC:EMC). The cells were cycled between 3 and 4.2 V using a protocol containing three formation cycles at C/10 rate, followed by 100 aging cycles at C/3 rate, and another three cycles at C/10 rate. The comparative B cell and the FE-3 cell exhibited similar initial capacity at about 1153 mAh/g. However, the capacity retention of the FE-3 electrolyte was much higher than that of the comparative cell. For example, the FE-3 cell has capacity retention of 98.5% after 100 aging cycles, where the comparative cell has a capacity retention of 38.2% after 100 aging cycles. The DME comparative cell showed the worst cycling performance due to significant electrolyte decomposition at high voltage.

FIG. 1B is an illustration of the Coulombic efficiency (CE) of Li∥NMC622 coin cells using the Gen 2-2% VC, DME, or FE-3 electrolyte. The initial CE of FE-3 cell is lower than that of Gen 2-2% VC cell. However, the average CE of FE-3 cell during 100 aging cycles (99.4%) is significantly higher than that of Gen 2-2% VC cell (98.2%). The DME cell exhibits very low CE after the first cycle.

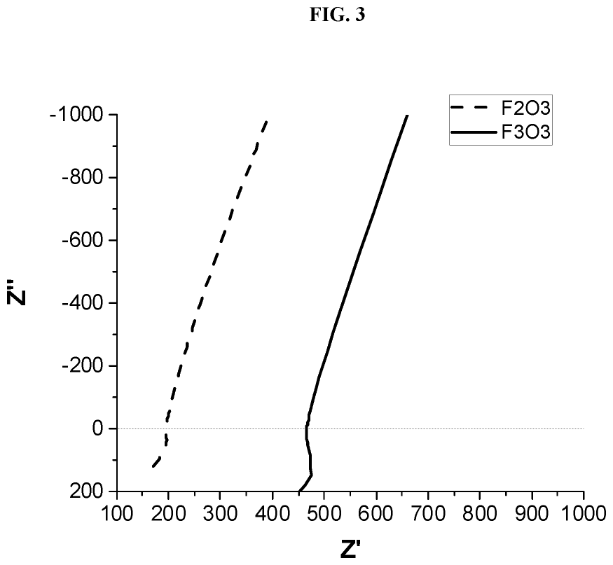

Example 3. Linear sweep voltammetry (LSV) tests were obtained for 2032 coin cells, and are shown in FIG. 2. The cells included a Li metal anode, a Celgard 2325 separator, and a Al foil as counter electrode. The electrolytes are 1 M LiTFSI in F2O3 or F3O3. The cells were subjected to a constant voltage sweep from 2.7 V to 7.0 V at a rate of 10 mV/s. Both electrolytes showed excellent oxidative stability with no obvious decomposition until 5.5 V.

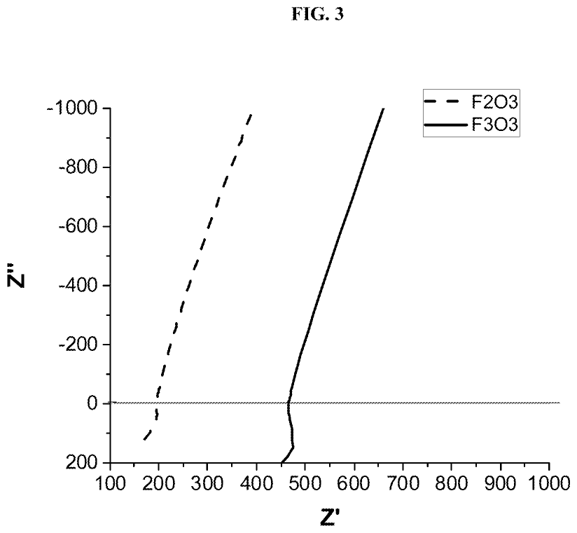

The ionic conductivity of the electrolytes was measured using electrochemical impedance spectroscopy (EIS). See FIG. 3. The 2032 coin cells used for the tests included a Teflon ring that filled with electrolyte that is sandwiched between two stainless steel current collectors. The electrolytes are 1 M LiTFSI in F2O3 or F3O3. The electrochemical impedance of the cells was tested in the frequency range from 1 MHz to 0.1 Hz. Ionic conductivity can be calculated using the Z′ intercept at a high frequency range obtained from the Nyquist plot of the EIS spectrum. Both electrolytes showed high ionic conductivity.

While certain embodiments have been illustrated and described, it should be understood that changes and modifications can be made therein in accordance with ordinary skill in the art without departing from the technology in its broader aspects as defined in the following claims.

The embodiments, illustratively described herein may suitably be practiced in the absence of any element or elements, limitation or limitations, not specifically disclosed herein. Thus, for example, the terms “comprising,” “including,” “containing,” etc. shall be read expansively and without limitation. Additionally, the terms and expressions employed herein have been used as terms of description and not of limitation, and there is no intention in the use of such terms and expressions of excluding any equivalents of the features shown and described or portions thereof, but it is recognized that various modifications are possible within the scope of the claimed technology. Additionally, the phrase “consisting essentially of” will be understood to include those elements specifically recited and those additional elements that do not materially affect the basic and novel characteristics of the claimed technology. The phrase “consisting of” excludes any element not specified.

The present disclosure is not to be limited in terms of the particular embodiments described in this application. Many modifications and variations can be made without departing from its spirit and scope, as will be apparent to those skilled in the art. Functionally equivalent methods and compositions within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds compositions or biological systems, which can of course vary. It is also to be understood that the terminology used herein is for the purpose of describing particular embodiments only, and is not intended to be limiting.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, particularly in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” “greater than,” “less than,” and the like, include the number recited and refer to ranges which can be subsequently broken down into subranges as discussed above. Finally, as will be understood by one skilled in the art, a range includes each individual member.

All publications, patent applications, issued patents, and other documents referred to in this specification are herein incorporated by reference as if each individual publication, patent application, issued patent, or other document was specifically and individually indicated to be incorporated by reference in its entirety. Definitions that are contained in text incorporated by reference are excluded to the extent that they contradict definitions in this disclosure.

Other embodiments are set forth in the following claims.

What is claimed is:

1. An electrochemical cell comprising:
a cathode comprising a cathode active material;
an anode comprising silicon, conductive carbon, lithium metal, sodium metal, magnesium metal, or a combination of any two or more thereof;
a separator; and
an electrolyte comprising:
a lithium salt; and
an asymmetric fluorinated glycol ether.

2. The electrochemical cell of claim 1, wherein the electrolyte comprises greater than 20 wt % of the asymmetric fluorinated glycol ether.

3. The electrochemical cell of claim 1, where in the electrolyte further comprises an electrolyte additive, an aprotic gel polymer, or a mixture of any two or more thereof.

4. The electrochemical cell of claim 3, wherein the electrolyte consists essentially of the lithium salt, the asymmetric fluorinated glycol ether, and optionally the electrolyte additive.

5. The electrochemical cell of claim 1, wherein the asymmetric fluorinated glycol ether is a compound represented by Formula I:
R¹(O(CH₂)ₘ)ₓOR² (I);
wherein:
R¹ is a C₁-C₈ alkyl substituted with 2 to 17 fluorine atoms;
R² is a C₁-C₆ alkyl;
m is 1, 2, or 3; and
x is 1, 2, 3, 4, 5, 6, 7, 8, 9 or 10.

6. The electrochemical cell of claim 5, wherein
R¹ is —(CH₂)_{q}(CR³R⁴)ₚR⁵;
R³ and R⁴ are each independently H or F;
R⁵ is —CHF₂ or —CF₃; and
q and p are each independently 1, 2, 3, or 4, with the proviso that q+p≤7.

7. The electrochemical cell of claim 6, wherein:
R³ and R⁴ are F;
q is 1 or 2; and
p is 1, 2, or 3.

8. The electrochemical cell of claim 6, wherein R⁵ is —CF₃.

9. The electrochemical cell of claim 5, wherein R² is CH₃, CH₂CH₃, or CH₂CH₂CH₃.

10. The electrochemical cell of claim 5, wherein R² is CH₃.

11. The electrochemical cell of claim 1, wherein the asymmetric fluorinated glycol ether is: 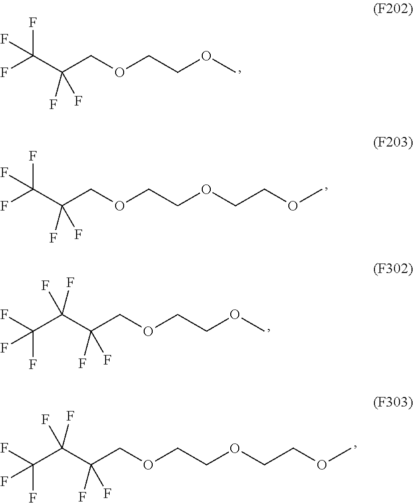 [SMILES: COCCOCC(F)(F)C(F)(F)F ; COCCOCCOCC(F)(F)C(F)(F)F ; COCCOCC(F)(F)C(F)(F)C(F)(F)F ; COCCOCCOCC(F)(F)C(F)(F)C(F)(F)F]
or a mixture of any two or more thereof.

12. The electrochemical cell of claim 1, wherein the electrolyte additive comprises LiBF₂(C₂O₄), LiB(C₂O₄)₂, LiPF₂(C₂O₄)₂, LiPF₄(C₂O₄), LiPF₆, LiAsF₆, CsF, CsPF₆, LiN(SO₂CF₃)₂, LiN(SO₂F)₂, Li₂(B₁₂X₁₂₋ᵢHᵢ); Li₂(B₁₀X_{10-i′}H_{i′}), or a mixture of any two or more thereof;
wherein:
each X is independently a halogen;
each i is an integer from 0 to 12; and
each i′ is an integer from 0 to 10.

13. The electrochemical cell of claim 2, wherein the electrolyte additive is present at a concentration of from 0.01 wt % to about 5 wt %.

14. The electrochemical cell of claim 1, wherein the lithium salt is a lithium fluorinated sulfonylimide salt.

15. The electrochemical cell of claim 14, wherein the lithium fluorinated sulfonylimide salt comprises LiN(SO₂F)₂; LiN(SO₂CF₃)₂; LiN(SO₂C₂F₅)₂; Li(SO₂F)N(SO₂CF₃); Li(SO₂F)N(SO₂CH₃); Li(SO₂F)N(SO₂C₂H₅); Li(SO₂F)N(SO₂C₂F₅); Li(SO₂F)N(SO₂CHF₂); Li(SO₂F)N(SO₂CH₂F); Li(SO₂F)N(SO₂CH₂CF₃); Li(SO₂F)N(SO₂CH₂CHF₂); Li(SO₂F)N(SO₂CHFCH₃); Li(SO₂F)N(SO₂CHFCF₃); Li(SO₂F)N(SO₂CHFCHF₂); Li(SO₂F)N(SO₂CHFCH₂F); Li(SO₂F)N(SO₂CF₂CH₃); Li(SO₂F)N(SO₂CF₂CF₃); Li(SO₂F)N(SO₂CF₂CHF₂); Li(SO₂F)N(SO₂CF₂CH₂F); Li(SO₂CF₃)N(SO₂CH₃); Li(SO₂CF₃)N(SO₂CHF₂); Li(SO₂CF₃)N(SO₂CH₂F); Li(SO₂CF₃)N(SO₂CH₂CF₃), or a mixture of any two or more thereof.

16. The electrochemical cell of claim 15, wherein the lithium fluorinated sulfonylimide salt comprises LiN(SO₂F)₂ or LiN(SO₂CF₃)₂.

17. The electrochemical cell of claim 2, wherein the aprotic gel polymer is present.

18. The electrochemical cell of claim 1 that is a lithium secondary battery or lithium-air battery.

19. The electrochemical cell of claim 1, wherein the cathode active material comprises O₂, S, a spinel, an olivine, a carbon-coated olivine LiFePO₄, LiMn_{0.5}Ni_{0.5}O₂, LiCoO₂, LiNiO₂, LiNi₁₋ₓCo_{y}Me_{z}O₂, LiNi_{α}Mn_{β}Co_{γ}O₂, LiMn₂O₄, LiFeO₂, LiNi_{0.5}Me_{1.5}O₄, Li_{1+x′}NiₕMnₖCoₗMe²_{y′}O_{2-z′}F_{z′}, VO₂ or E_{x″}E′₂(Me₃O₄)₃, LiNiₘMnₙO₄, or a mixture of any two or ore thereof, wherein Me is Al, Mg, Ti, B, Ga, Si, Mn, or Co; Me² is Mg, Zn, Al, Ga, B, Zr, or Ti; E is Li, Ag, Cu, Na, Mn, Fe, Co, Ni, or Zn; E′ is Ti, V, Cr, Fe, or Zr; wherein 0≤x≤0.3; 0≤y≤0.5; 0≤z≤0.5; 0≤m≤2; 0≤n≤2; 0≤x′≤0.4; 0≤α≤1; 0≤β≤1; 0≤γ≤1; 0≤h≤1; 0≤k≤1; 0≤l≤1; 0≤y′≤0.4; 0≤z′≤0.4; and 0≤x″≤3; with the proviso that at least one of h, k and l is greater than 0.

20. The electrochemical cell of claim 1, wherein the anode comprises lithium metal.
